(19) United States
(12) Patent Application Publication
(10) Pub. No.: US 2004/0197571 A1
(43) Pub. Date: Oct. 7, 2004

(54) Thermosetting composition, and sealing article and sealing structure using the same

(76) Inventors: Yuji Hiroshige, Hachioji-city (JP); Shuichi Kitano, Sagamihara-city (JP); Tomohiro Koiwa, Sagamihara-city (JP); Kotaro Shinozaki, Yokohama (JP)

Correspondence Address: 3M INNOVATIVE PROPERTIES COMPANY, PO BOX 33427, ST. PAUL, MN, 55133-3427, US

(21) Appl. No.: 10/406,175

(22) Filed: Apr. 3, 2003

(51) Int. Cl. B32B 27/00

(52) U.S. Cl. 428/424.2; 428/522

(57) ABSTRACT

A sealing article and sealing structure are described that include a thermosetting composition. The thermosetting composition includes an epoxy-containing material, a curing agent for the epoxy-containing material, a non-metallic filler, and a plasticizer. The epoxy-containing material includes a how hygroscopic epoxylated ethylene-type thermoplastic resin or a low hygroscopic epoxylated styrene-type thermoplastic resin.

### TECHNICAL FIELD

The present invention relates to a sealing article and sealing structure that include a thermosetting composition.

### BACKGROUND ART

Vehicles such as automobiles and trucks have a discontinuous joint resulting from the superposition of metal panels. Such a discontinuous joint is usually sealed by a sealant. One example of non-planar overlapping-type joints is a roof ditch. The roof ditch is formed to run in the longitudinal direction of a vehicle by bending and overlapping the roof panel and the side edge part of the side panel with each other. The roof ditch has a U-shaped trough and also plays a role of collecting water or the like and draining it away outside the vehicle.

The sealant is supplied as a liquid or solid material according to the requirement of the application. For example, in the automobile industry, the joint is usually sealed using a liquid plastisol comprising polyvinyl chloride (PVC) or the like. However, a liquid sealant is difficult to apply depending on the site. In some cases, use of a sealing article having a fixed shape such as sheet or tape is necessary.

### SUMMARY OF THE INVENTION

The invention provides a sealing article that includes a thermosetting composition. The thermosetting composition includes an epoxy-containing material, a curing agent for the epoxy-containing material, a non-metallic filler, and a plasticizer. The epoxy-containing material contains a low hygroscopic epoxylated thermoplastic resin such as an epoxylated ethylene-type thermoplastic resin or an epoxylated styrene-type thermoplastic resin.

Another aspect of the invention provides a sealing structure that includes an adherend having a discontinuous part and a thermosetting composition disposed in said discontinuous part to seal the discontinuous part. The thermosetting composition includes an epoxy-containing material, a curing agent for the epoxy-containing material, a non-metallic filler, and a plasticizer.

### BRIEF DESCRIPTION OF DRAWINGS

FIG. 1 is a side cross-sectional view showing one preferred embodiment of the sealing structure according to the present invention.

FIG. 2 is a side cross-sectional view showing one preferred embodiment of the sealing article according to the present invention.

The practical embodiments of the present invention are described in detail below, however, it would be easily understood by one skilled in the art that the present invention is by no means limited only to these embodiments.

### DETAILED DESCRIPTION OF THE INVENTION

The present invention provides a thermosetting composition capable of adhering to a discontinuous part with sufficiently high heat resistance and durability while maintaining the appearance of the coating of paint. The invention also provides a sealing article and a sealing structure using the thermosetting composition.

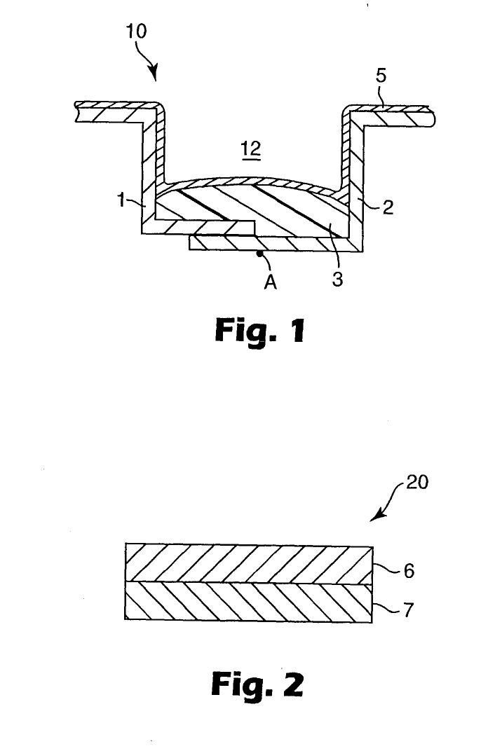

The thermosetting composition of the present invention can be used for sealing a joint, step joint, weld, joint weld, crack or other portions (hereinafter, these portions are collectively called “discontinuous part”) of vehicle parts. FIG. 1 shows one example of a sealant structure formed by sealing a discontinuous part using the thermosetting composition of the present invention.

The sealing structure 10 shown in FIG. 1 can be manufactured by applying the thermosetting composition of the present invention to the joint A of an adherend called a roof ditch where a U-shaped trough is formed by working two sheets of panels 1 and 2 to make a right angle with each other. In general, the roof ditch is seen in vehicles such as automobiles and trucks. Such a roof ditch is usually formed in the longitudinal direction of a vehicle by bending and overlap-welding the side edge part of a roof panel 1 and the side edge part of a side panel 2 of a vehicle with each other. This roof ditch has a joint A as a discontinuous part and the joint is covered and sealed by a thermosetting composition 3, whereby water, dust and other contaminants are prevented from getting into the joint and causing corrosion. In the automobile industry, a coating of paint 5 is provided on the thermosetting composition 3, if desired.

Other discontinuous parts can be sealed with a sealing article of the invention. For example, the sealing article can be applied to any part of a vehicle body that includes the joining of two or more pieces of metal. In one embodiment, a sealing article of the invention is positioned where two or more pieces of metal are joined to form a door. A door for a vehicle is typically formed, for example, by bending a first piece of metal that is part of the outer side of a door over a second piece of metal that is part of the inner side of the door. In one specific example, the sealing article can be adhered to a side sill on the downside of a door part. In another embodiment, the sealing article can be positioned in the wheel well to seal where a piece of metal that forms part of the outer body of the car is bent over the metal that forms the wheel well of a vehicle. The sealing article can be used to seal other parts of the vehicle body that have a three-dimensional shape.

The sealing article preferably has poor water absorptivity. The presence of water in the sealing article can result in the swelling of the sealing article due to the bubbling of the water content when the article is cured by heating. The swelling can lead to adhesion failure to the discontinuous, layer separation or lifting, and the invasion of water or other contaminants. Furthermore, even if a coating of paint is provided on the surface of a vehicle in the coating step similarly to the case of a general sealant, the sealing article may not satisfactorily adhere to the coating of paint or may provide a defective appearance to the coating of paint.

Defects in the paint coating may also be formed due to the stress generated on the interface between the sealing article and the coating of paint that are different in the coefficient of thermal expansion at a temperature as low as −40 to −20° C. This tendency is strong particularly when the sealing article is applied to the trough part of the roof ditch. The coating of paint on the sealing article is not only subject to the stress on the interface with the sealing article but also bound to the side wall of the trough part and is liable to rupture relatively easily. Furthermore, in the case where the sealing article exhibits a relatively low modulus at the above-described low temperatures, cracking of the coating of paint is anticipated due to the reduction in the stress generated on the interface between the sealing article and the coating of paint.

The thermosetting composition of the present invention can be used as a sealant. The thermosetting compositions include an epoxy-containing material, a curing agent for the epoxy-containing material, a non-metallic filler, and a plasticizer. These components are described in detail below.

Epoxy-Containing Material

The epoxy-containing material used as the first component of the thermosetting composition of the present invention contains a low hygroscopic epoxylated thermoplastic resin, an epoxy resin, and an optional compatibilizer. The epoxylated thermoplastic resin typically includes an epoxylated ethylene-type thermoplastic resin or an epoxylated styrene-type thermoplastic resin.

The epoxylated thermoplastic resin is a thermoplastic resin having an epoxy group. In general, the thermoplastic resin can impart a fixed shape to the thermosetting composition and the epoxylated thermoplastic resin contributes to the heat curing reaction due to the presence of an epoxy group. By virtue of these effects, when the thermosetting composition is cured, the cured product can have heat resistance and durability. In the case of use as a sealer for the roof ditch of an automobile, the epoxy group enhances the adhesive property of the cured product to an automobile steel sheet applied with an automobile paint (for example, an organic solvent-type acrylic paint or an organic solvent-type alkyl paint) and a cationic electrodeposition coating. The capability of the cured product to adhere to an automobile paint is advantageous for the coating process of an automobile, because at the coating of the automobile body, the color of the cured product can be made identical to the color of the automobile body. As a result, a covering member such as chenille can be dispensed with and the automobile body can have good appearance and aesthetic surface. The capability of adhering to a steel sheet in turn improves the durability and sealability of the sealer.

In the thermosetting composition of the present invention, the epoxylated thermoplastic resin has low hygroscopicity. Because of the low hygroscopicity, the thermosetting composition can be prevented from absorbing water. Absorbed water can decrease the adhesion of the sealant. In addition, the handling such as storage can be simplified when the thermosetting composition has low hygroscopicity. The term “low hygroscopicity” as used herein means that the epoxylated thermoplastic resin has a saturation water absorption of 0.2 wt % or less at 35° C. and a relative humidity of 80% RH. Such an epoxylated thermoplastic resin usually has a solubility parameter (SP) of about 9 or less. The solubility parameter as used in the present invention has a meaning defined by the Small formula (described in P. A. Small, J. Appl. Chem., 3, 71 (1953)).

The epoxylated thermoplastic resin usually has a molecular weight of 1,000 to 10,000 to provide flowability at the fabrication and heat melting. Furthermore, the epoxylated thermoplastic resin generally has an epoxy equivalent of 200 to 15,000 to provide heat resistance, durability, adherence to film, and water absorptivity.

One typical example of the epoxylated thermoplastic resin is an epoxylated ethylene-type thermoplastic resin. This resin exhibits low hygroscopicity by virtue of the ethylene moiety. In some embodiments, the epoxylated ethylene-type thermoplastic resin is an ethylene-glycidyl (meth)acrylate copolymer. This ethylene-glycidyl (meth)acrylate copolymer is disclosed as one component of an adhesive or a hot-melt composition in Japanese Unexamined Patent Publication Nos. 9-137028 and 10-316955. The copolymer can be obtained by copolymerizing ethylene and glycidyl methacrylate. Thus, the ethylene-glycidyl (meth)acrylate copolymer is constructed by an ethylene moiety and a glycidyl (meth)acrylate moiety. The ethylene moiety contributes to the low hygroscopicity of the thermosetting composition and the glycidyl (meth)acrylate moiety contributes to the adhesive property to an automobile steel sheet applied with an automobile paint and a cationic electrodeposition coating.

The ethylene-glycidyl (meth)acrylate copolymer is typically constructed such that the monomer weight ratio of ethylene to glycidyl (meth)acrylate is from 50:50 to 99:1. If the ethylene-glycidyl (meth)acrylate copolymer is constructed by containing ethylene in excess of the upper limit, the cured product can be difficult to have desired mechanical strength and durability, whereas if the ethylene contained in the ethylene-glycidyl (meth)acrylate copolymer is less than the lower limit, the desired low hygroscopicity may not be obtained.

Typically, the ethylene-glycidyl (meth)acrylate copolymer readily melts even at a relatively low temperature of about 120° C. or less. When a thermosetting composition containing the copolymer is heated on sealing, the composition can exhibit high fluidity that can result in an appearance that is uniform and smooth. Furthermore, in the heat-mixing process at the manufacture of a sealer, the kneading can be performed at a relatively low temperature. The low temperature can be used to minimize reactivity between the heat curing component and allows selection of a curing agent having higher reactivity.

As long as the effect of the present invention is not impaired, the epoxylated thermoplastic resin may be a ternary ethylene-glycidyl (meth)acrylate copolymer obtained by copolymerizing or graft-polymerizing a third component other than ethylene and glycidyl (meth)acrylate. Examples of the ternary copolymer include those obtained by copolymerizing alkyl (meth)acrylate or vinyl acetate. Examples of the graft polymer include those obtained by grafting polystyrene, polyalkyl (meth)acrylate or acrylonitrile-styrene copolymer.

Another typical example of the epoxylated thermoplastic resin is an epoxylated styrene-type thermoplastic resin. This resin exhibits low hygroscopicity due to the presence of a conjugate diene. The epoxylated styrene-type thermoplastic resin is a block copolymer having a hard segment that includes, for example, polystyrene and a soft segment that includes, for example, an epoxylated polybutadiene and having capability of imparting rubber elasticity to the elastomer thereof. In place of or together with the epoxylated polybutadiene, an epoxylated polyisoprene may also be used.

The epoxylated styrene-type thermoplastic resin usually has a glass transition temperature (Tg) as low as −70 to −50° C. By virtue of this, the thermosetting composition of the present invention can provide a cured product improved in the durability (particularly durability against vibration) at a low temperature to about −30° C. Therefore, this epoxylated styrene-type thermoplastic resin can be advantageous in the use as a sealer for the portion repeatedly subjected to a stress at a low temperature, for example, as a sealer for the above-described roof ditch of an automobile. In the use as a sealer for the roof ditch of an automobile, the styrene moiety and the epoxy group of the epoxylated styrene-type thermoplastic resin ensure adhesion of the cured product to an automobile steel sheet applied with an automobile paint (for example, an organic solvent-type acrylic paint or an organic solvent-type alkyd paint) and a cationic electrodeposition coating.

Examples of the epoxylated styrene-type thermoplastic resin include a styrene-epoxylated butadiene-styrene copolymer and a styrene-epoxylated isoprene-styrene copolymer. In either case, the epoxylation is attained by epoxylating an unsaturated bond of the conjugate diene.

This low hygroscopic epoxylated thermoplastic resin is preferably contained in the thermosetting composition in an amount of 10 to 90 wt %. If the content is less than about 10 wt %, the heat resistance and low hygroscopicity may decrease, whereas if it exceeds about 90 wt %, the filler content is relatively reduced and a low coefficient of linear expansion may not be obtained.

The epoxy-containing material may contain, in addition to the above-described epoxylated thermoplastic resin, a liquid or solid epoxy resin such as bisphenol A-type epoxy resin, bisphenol F-type epoxy resin, novolak-type epoxy resin and glycidyl amine-type epoxy resin. In some embodiments, the epoxy resin can improve the heat resistance, durability and adhesion of the cured product of the thermosetting composition to the above-described automobile paint.

The epoxy resin is typically an epoxy resin having a relatively low polarity and examples thereof include linear aliphatic epoxy resins such as hydrogenated bisphenol A-type epoxy resin, alicyclic epoxy resin and butadiene skeleton epoxy resin, and glycidyl ester-type epoxy resins such as dimeric acid-modified epoxy resin. This epoxy resin is typically compatible with the low water-absorbing component, for example, ethylene moiety or butadiene moiety, contained in the above-described epoxylated thermoplastic resin. The cured product can be a low water absorbing material, which is advantageous for the coating process of an automobile as described above. The amount of the epoxy resin is usually from 0 to about 500 parts by weight per 100 parts by weight of the low hygroscopic epoxylated thermoplastic resin. In some embodiments, the amount of epoxy resin is about 5 to about 400 parts by weight per 100 parts by weight of the low hygroscopic epoxylated thermoplastic resin.

The epoxy-containing material may further contain a compatibilizer, if desired. The compatibilizer can be used in an amount of 0 to about 300 parts by weight per 100 parts by weight of the low hygroscopic epoxylated thermoplastic resin. In some embodiments, the compatiblizer is present in an amount of about 1 to about 100 parts by weight per 100 parts by weight of the low hygroscopic epoxylated thermoplastic resin. In some embodiments, the compatibilizer can be used to improve the compatibility between the low hygroscopic epoxylated thermoplastic resin and the epoxy resin. As long as this compatibility can be attained, the compatibilizer is not particularly limited in the present invention, but suitable examples thereof include a polyester resin and an ethylene-vinyl acetate copolymer (EVA). For example, when a polyester resin is blended with the low hygroscopic epoxylated thermoplastic resin, the separation between the low hygroscopic epoxylated thermoplastic resin and the epoxy resin can be minimized and the fluidity at the curing temperature of the thermosetting composition (about 100 to about 160° C.) can be improved.

Curing Agent for Epoxy-Containing Material

The curing agent cures the epoxy group contained in the epoxylated thermoplastic resin and the epoxy resin, and provides a crosslinked structure to the thermosetting composition of the present invention, whereby a cured product can be obtained.

The curing agent is not particularly limited as long as a cured product can be obtained. The curing agent may contain an amine compound such as dicyandiamide, an acryl compound or rosin having a carboxyl group (including acid anhydride) within the molecule, an imidazole derivative, a BF₃ complex, an organic acid hydrazide, a diaminomaleonitrile, a melamine, or a mixture thereof. The polarity of the curing agent is also not particularly limited.

In some embodiments, as disclosed in Japanese Unexamined Patent Publication Nos. 9-137028 and 10-316955, the curing agent contains an acryl compound or rosin having a carboxyl group within the molecule. Such a curing agent is readily compatibilized with the ethylene-glycidyl (meth)acrylate copolymer to cure the glycidyl group of the ethylene-glycidyl (meth)acrylate copolymer. A curing agent having high polarity is not compatibilized with the ethylene-glycidyl (meth)acrylate copolymer and substantially no reaction takes place with the copolymer.

The curing agent may be used in combination with a curing accelerator. For example, the reaction of a curing agent having a carboxyl group with epoxy can be accelerated by using a curing accelerator that contains a phenol, an imidazole derivative, or a tertiary amine.

Filler and Plasticizer

In the present invention, a filler containing, for example, calcium carbonate, silica or a mixture thereof is further added to the thermosetting composition. The fillers are non-metallic. The filler can reduce the coefficient of linear expansion of the cured product. The lower coefficient of linear expansion and the corresponding reduced percent shrinkage at low temperatures can result in a cured product that is not easily cracked when used as a coating on the above-described automobile paint.

A thermosetting composition having a filler can have an undesirable fluidity upon heat-melting. Therefore, the thermosetting composition of the present invention can also contains a plasticizer. By containing a plasticizer, the thermosetting composition of the present invention can hold the desired fluidity, because the plasticizer in general has low viscosity and contributes to the improvement in fluidity of a composition.

Examples of the plasticizer that can be contained in the thermosetting composition of the present invention includes plasticizers containing a phthalic acid ester such as di-2-ethylhexyl phthalate and diisononyl phthalate, an adipic acid ester, an epoxylated fatty acid ester, epoxylated soybean oil, epoxylated linseed oil, liquid terpene resin, liquid terpene phenol copolymer, liquid terpene styrene copolymer, an azelaic acid ester, a sebacic acid ester, an epoxyhexaphthalic acid ester or a mixture thereof. Such a plasticizer can impart flexibility to the cured product of the thermosetting composition. Furthermore, the cured product can be reduced in the glass transition temperature and in turn reduced in the modulus even at a low temperature of −20 to 40° C. As a result, the cured product can be greatly elongated at such a low temperature and can be improved in the dynamic durability such as vibration durability.

The thermosetting composition can be formed into a sealing article having a fixed shape, such as sheet, tape, rope or strap, and then used.

The sealing article can be disposed on a discontinuous part such as joint and heated. The sealing article can be heat-melted and fluidized to seal the discontinuous part. More specifically, the sealing article is softened when it is heated in the state of covering a discontinuous part, and thereby fitted to the surface of the discontinuous part and at this time, the trapped air is expelled. Thereafter, the sealing article is cured by heating (namely, crosslinked through a covalent bond) and subsequently cooled so as to prevent it from flowing even when heated again.

In the automobile industry, the discontinuous part is found, for example, in the roof ditch and the sealing article is applied thereto. In this case, the sealing article is bound to not only the bottom surface but also the side wall of the roof ditch. The roof ditch sometimes imposes a stress on the sealing article from the side wall due to the distortion or deflection of the panels constituting the roof ditch. However, by virtue of the elasticity of the thermoplastic composition, the sealing article of the present invention can flexibly follow the stress imposed from the side wall at a relatively low temperature of about −30° C. and cannot be easily cracked, whereby invasion of dust, water or other contaminants can be prevented.

In the automobile industry, the sealing article of the roof ditch is prepared by heat-melting, fluidization, and curing of the thermosetting composition before a coating of paint is provided. The coating of paint is also bound to the side wall of the roof ditch and additionally to the sealing article. As a result, an interfacial stress is generally generated between the coating of paint and the sealing article. This interfacial stress is observed at low temperatures in many cases, because typical sealing articles are readily shrunk at low temperatures. On the assumption that the interfacial stress (P) is usually relaxed at a temperature higher than the glass transition temperature (Tg) of the sealing article, the interfacial stress at a temperature (T) lower than the glass transition temperature of the sealing article can be represented by the following formula:

P=ΔT·E·Δα

wherein ΔT: T-Tg,

E: modulus of sealing article, and

Δα: difference in the coefficient of linear expansion between coating of paint and sealing article.

The sealing article of the present invention has a low modulus as described above and a small difference in the coefficient of linear expansion. Therefore, at temperatures lower than the glass transition temperature (−30 to −10° C.) of the sealing article of the present invention, for example, at a low temperature of −40 to −20° C., the stress can be diminished and the coating of paint can be prevented from cracking.

The sealing article of the present invention, as described above, has a low water content before and after the curing. Therefore, even if the sealing article is left standing under high-temperature and high-pressure conditions for a few days before the coating, the sealing article typically does not have problems ascribable to the expansion caused by the bubbling of the water content in the coating process. More specifically, the sealing articles typically do not fail to adhere to the discontinuous part. There is typically no layer separation or lifting so contamination from dust, water, and the like can be avoided. Furthermore, this sealing article can satisfactorily adhere to a coating of paint and also can provide an aesthetic appearance to the coating of paint.

In the foregoing pages, the present invention is described by referring to the preferred embodiments but the present invention is by no means limited thereto.

For example, the thermosetting composition of the present invention may contain a crystallizing agent such as, for example, fine particulate metal, inorganic particles, crystalline polymer, and organic pigments. When the thermosetting composition contains a crystalline resin such as polyester, the crystallizing agent can accelerate the crystallization of the crystalline resin and thereby the thermosetting composition and the sealing article as a formed article of the composition can be prevented from changing in the capability with the passing of time.

Within the range of not impairing the effect of the present invention, the thermosetting composition may further contain a modifier for improving the adhesive property to the coating of paint formed on the composition. The modifier can be a tackiness-imparting agent such as terpene-type resin, or an olefin copolymer having copolymerized therein a relatively high-polarity component.

In the inside or on one or both surfaces of the sealing article, at least one barrier layer comprising a non-woven fabric, a resin such as polyester (e.g., polyethylene terephthalate (PET), polyethylene naphthalate (PEN)) and nylon, a metal or the like may be provided. When an air bubble enters into the sealing article from the discontinuous surface of the sealing portion during heating and melting, the barrier layer can trap the air bubble inside the sealing article. That is, the barrier can prevent the air bubble from coming out on the surface of the sealing article and can maintain or improve the aesthetic appearance of the coating of paint. Furthermore, the barrier layer can support the sealing article and thereby improve the handleability. The barrier layer may also be formed by irradiating radiation such as electron beam on the surface of the sealing article and thereby providing a cross-linked structure to the surface.

The present invention is not limited to the above-described sealing article fundamentally constructed by a thermosetting composition where respective components are uniformly blended. FIG. 2 is a side cross-sectional view showing another practical embodiment of the sealing article of the present invention. This sealing article 20 is a two-layer type and includes an upper layer 6 on which a coating of paint may be provided, and a lower layer 7 which comes into contact with an adherend having a discontinuous part. Each layer can contain an epoxy-containing material and a curing agent therefor but in the lower layer, a filler is partially contained. The plasticizer can be partially contained in the upper layer. In this case, the plasticizer and the filler are separated from each other and both the shrinkage of the sealing article itself and the stress on the coating of paint can be effectively relaxed.

The present invention is not limited to sealing of a roof ditch and the like but can also be applied to seal any part of a vehicle where two or more pieces of metal are joined. For example, the sealing article can be applied to the lower part of the side sill on the downside of the door part of a vehicle. The lower part of the side sill is disposed in the linear side of a front wheel tire and subject to impacts from pebbles and gravel on the road that are flipped by the front wheel tire during the running of the vehicle. By coating the side sill with the thermosetting composition, such destruction cause by such impacts can be reduced. The thermosetting composition can have a relatively soft rubber elasticity after the curing. Accordingly, a cover member comprising, for example, a resin needs not be provided to the lower part of the side sill so as to prevent the noise/vibration due to the impact of chipping. As a result, the weight of the vehicle can be reduced.

In the case where the thermosetting composition is formed into a specific shape such as sealing article, good handleability can be attained as compared with PVC sol or one-liquid urethane sealer, for which a coating robot is necessary. Therefore, use of PVC sol can be reduced.

This thermosetting composition shows relatively low fluidity even when heated. Therefore, the thermosetting composition coated on the overhang surface at the lower part of the side sill scarcely drips therefrom. This can dispense with any means for the coating on the overhang surface.

The cured product of the thermosetting composition can be coated with a paint for steel sheet, therefore, by coating a paint having the same color, for example, as the vehicle body, an aesthetic appearance can be easily provided to the vehicle.

### EXAMPLES

The present invention is described below by referring to the Examples, however, needless to say, the present invention is by no means limited thereto.

### Example 1

Preparation of Thermosetting Composition and Manufacture of Sealing Article

The following components were charged into a twin-screw extruder having an axis diameter of 30 mm and then kneaded to prepare a thermosetting composition.

(1) 30 parts by mass of an ethylene-glycidyl methacrylate copolymer containing 18 mass % of glycidyl methacrylate (CG5001, trade name, produced by Sumitomo Chemical Co., Ltd.);

(2) 70 parts by mass of a thermoplastic polyester resin (compatibilizer, S320, trade name, produced by Huls);

(3) 60 parts by mass of an epoxy resin having an epoxy equivalent of. 190 (YD128, trade name, produced by Toto Kasei);

(4) 20 parts by mass of an epoxy resin having an epoxy equivalent of 600 to 700 (Epicote 1002, trade name, produced by Yuka Shell);

(5) 6 parts by mass of dicyandiamide (curing agent, H3636AS, trade name, produced by ACR);

(6) 4 parts by mass of an imidazole derivative (curing accelerator, 2MZA, trade name, produced by Shikoku Kasei);

(7) 50 parts by mass of calcium carbonate (filler, Whiton SB, trade name, produced by Shiraishi Calcium); and

(8) 2 parts by mass of a crystallizing agent (Unilin 425, trade name, produced by Toyo Petrolite).

Thereafter, this thermosetting composition was taken out from the twin-screw extruder and coated on one surface of a PET film carrier using a hot knife coater (comma coater type) to form a sheet (sealing article) having a thickness of 2.0 mm.

Subsequently, this sheet was cut into a tape having a length of 150 cm and a width of 3 cm (hereinafter sometimes referred to as a “melt sheet tape”) and used in the tests and measurements described later.

### Example 2

Using the following components, a melt sheet tape was manufactured in the same manner as in Example 1.

(1) 70 parts by mass of an ethylene-glycidyl methacrylate copolymer containing 18 mass % of glycidyl methacrylate (CG5001, trade name, produced by Sumitomo Chemical Co., Ltd.);

(2) 20 parts by mass of an epoxy resin having an epoxy equivalent of 200 (PB3600, trade name, produced by Daicel Kagaku Kogyo);

(3) 6 parts by mass of carboxyl group-containing rosin having an acid value of 240 mg KOH/g (curing agent, KE604, trade name, produced by Arakawa Kagaku);

(4) 2.5 parts by mass of an imidazole derivative (curing accelerator, 2MZA, trade name, produced by Shikoku Kasei);

(5) 20 parts by mass of diisononyl phthalate (plasticizer);

(6) 60 parts by mass of calcium carbonate (filler, Whiton SB, trade name, produced by Shiraishi Calcium); and

(7) 10 parts by mass of terpene-base resin (modifier, T0125, trade name, produced by Yasuhara Chemical).

### Example 3

Using the following components, a melt sheet tape was manufactured in the same manner as in Example 1.

(1) 40 parts by mass of an epoxylated styrene/isoprene/styrene copolymer having an epoxy equivalent of 727 (DSM105, trade name, produced by Daicel Kagaku Kogyo);

(2) 30 parts by mass of a polyester resin (compatibilizer, S1402, trade name, produced by Huls);

(3) 30 parts by mass of a polyester resin (compatibilizer, S320, trade name, produced by Huls);

(4) 30 parts by mass of an epoxy resin having an epoxy equivalent of 190 (YD-128, trade name, produced by Toto Kasei);

(5) 3.3 parts by mass of dicyandiamide (curing agent, H3636AS, trade name, produced by ACR);

(6) 4.9 parts by mass of carboxyl group-containing rosin having an acid value of 240 mg KOH/g (curing agent, KE604, trade name, produced by Arakawa Kagaku);

(7) 4.9 parts by mass of an imidazole derivative (curing accelerator, 2MZA, trade name, produced by Shikoku Kasei);

(8) 10 parts by mass of calcium carbonate (filler, Whiton SB, trade name, produced by Shiraishi Calcium);

(9) 70 parts by mass of silica (filler, FB-40S, trade name, produced by Asahi Denka);

(10) 15 parts by mass of di-2-ethylhexyl phthalate (plasticizer, produced by Kyowa Hakko Kogyo);

(11) 1.0 part by mass of a crystallizing agent (Unilin 425, trade name, produced by Toyo Petrolite); and

(12) 3.4 parts by mass of an antioxidant (Iranox 1010, trade name, produced by Ciba Geigy).

### Example 4

Preparation of Thermosetting Composition for Chipping Resistance and Manufacture of Sheet

The following components were charged into a twin-screw extruder having an axis diameter of 15 mm and then kneaded to prepare a thermosetting composition.

(1) 25 parts by mass of an epoxylated styrene/isoprene/styrene copolymer having an epoxy equivalent of 5333 (CT136, trade name, produced by Daicel Kagaku Kogyo);

(2) 75 parts by mass of a polyester resin (compatibilizer, S1402, trade name, produced by Huls);

(3) 35 parts by mass of an epoxy resin having an epoxy equivalent of 200 (PB3600, trade name, produced by Daicel Kagaku Kogyo);

(4) 29 parts by mass of carboxyl group-containing rosin having an acid value of 240 mg KOH/g (curing agent, KE604, trade name, produced by Arakawa Kagaku);

(5) 2.9 parts by mass of an imidazole derivative (curing accelerator, 2M-OK, trade name, produced by Shikoku Kasei);

(6) 34 parts by mass of calcium carbonate (filler, Whiton SB, trade name, produced by Shiraishi Calcium);

(7) 15 parts by mass of di-2-ethylhexyl phthalate (plasticizer); and

(8) 1.3 parts by mass of a crystallizing agent (Unilin 425, trade name, produced by Toyo Petrolite).

Thereafter, this thermosetting composition was taken out from the twin-screw extruder and coated on one surface of a PET film carrier using a hot knife coater (comma coater type) to form a sheet (sealing article) of 10 cm×20 cm having a thickness of 2.0 mm, and this sheet was used in the chipping resistance test described later.

Heat Cycle Test

The sheets and tapes of Examples 1 to 3 each was subjected to a heat cycle test as described below.

A substrate for use in the heat cycle test was manufactured as follows. A cold-rolled steel sheet having a depth of 25 mm and a thickness of 0.8 mm and applied with an automobile grade cationic electrodeposition coating (E-coating U-600 Black, produced by Nippon Paint) was bent to manufacture an adherend 30 having a U-shaped trough with a depth of 5 mm and a width of 8 mm as a simulation of the roof ditch described above.

The melt sealing tapes prepared above each was cut into a rectangular test piece having a length of 25 mm and a width of 7 mm. The test piece was disposed on the U-shaped trough and while keeping this state, these were placed in a constant temperature oven and heated at a temperature of 110° C. for 15 minutes. This simulates the preparatory drying of a sealing article in the production line of an automobile, which is called pre-cure.

Thereafter, the adherend was taken out together with the test piece from the oven and allowed to cool to room temperature (25° C., hereinafter the same). Then, a paint (namely, aminoalkyd paint where polyester is cross-linked by melamine) was sprayed thereon and the adherend was again placed together with the test piece in an oven and heated at a temperature of 140° C. for 18 minutes. The paint used is called an intermediate baking paint in the automobile industry. At this time, the intermediate baking paint coating had a thickness of 35 μm.

Subsequently, the adherend with the test piece was taken out from the constant temperature oven and allowed to cool to room temperature, and then a solid paint of aminoalkyd type where polyester is cross-linked by melamine was coated on the intermediate baking paint. This aminoalkyd-type solid paint is called a topcoat baking paint in the automobile industry. While keeping this state, the adherend with the test piece was again placed in the constant temperature oven and left standing at a temperature of 140° C. for 18 minutes. At this time, the topcoat baking paint coating had a thickness of 40 μm. Then, the sheet was taken out from the constant temperature oven and allowed to cool to room temperature to manufacture a test substrate for use in the heat cycle test described below.

Thereafter, the test substrate was placed in a cycle tester and heated according to the following cycle. The temperature was raised from room temperature to 90° C. and held at 90° C. for 4 hours. The temperature was then lowered to −40° C. and held for 1.5 hours. The temperature was raised to 70° C. The sample was held at 70° C. and 95% RH for 3 hours. The temperature was then lowered to −40° C. and held for 1.5 hours. The temperature was then increased to room temperature. After this cycle was repeated 10 times, the test substrate was taken out from the cycle tester and the appearance of the coating of paint on the test piece was examined with an eye, as a result, the coating of paint had no cracking in any of Examples 1 to 3.

Measurements of Low Temperature Elongation and Water Absorption

The melt seal tape of Example 1 was measured on the water absorption and the melt seal tape of Example 2 was measured on the low temperature elongation and the water absorption, as described below.

Measurement of Water Absorption

The melt seal tape (uncured) was cut into a rectangular shape of 40 mm×50 mm, then placed in an oven and left standing at a temperature of 35° C. and a relative humidity of 85% RH for 3 days. Thereafter, the melt seal tape was taken out from the oven and measured on the water content thereof by the Karl Fischer's method. As a result, the water content was found to be 0.36 wt % in Example 1 and 0.29 wt % in Example 2.

Measurement of Low Temperature Elongation

The melt seal tape was heated at a temperature of 110° C. for 15 minutes and subsequently, further heated at a temperature of 140° C. for 45 minutes to obtain a cured product. This cured product was punched by a dumbbell #1 to prepare a sample. The sample was pulled at a pulling speed of 50 mm/min and a temperature of −20° C. and measured on the elongation, as a result, the percent elongation thereof was found to be 88%.

Coating Adhesion Test and Hygroscopic Bubbling Test

The sheets and tapes of Example 3 were subjected to a coating adhesion test and a hygroscopic bubbling test described below.

Coating Adhesion Test

In this test, the same test substrate as used in the heat cycle test was prepared. The sheet of Example 3 was cut into a rectangular sample of 25 mm×50 mm and this sample was attached to the above-described cationic electrodeposition coated sheet and while keeping this state, these were pre-heated at a temperature of 110° C. for 15 minutes. Then, an automobile intermediate paint was coated on this sample and heated at a temperature of 140° C. for 18 minutes. On this automobile intermediate paint, an automobile topcoat baking paint was further coated and the thus-coated sample was heated at 140° C. for 18 minutes to manufacture a test substrate.

Using this test substrate, a so-called cross-cut adhesion test was performed according to the Japanese Industrial Standard JIS K5400. More specifically, the coating of paint and the adhesive composition each was scratched by a knife to draw a check pattern consisting of 25 squares. Subsequently, Cellophane Tape (trademark) produced by Nichiban was attached to the coating surface and then peeled off at once but the film was not peeled off. This cross-cut adhesion test was also performed by dipping the test substrate in warm water at 40° C. for 2 weeks but the coating was not peeled off.

Hygroscopic Bubbling Test

In this test, one standard test substrate and two comparative test substrates taking account of the imaginary moisture absorption in the production line of an automobile were manufactured as follows.

The standard test substrate was manufactured in the same manner as the test substrate for the heat cycle test except that a rectangular test piece of 7 mm×25 mm obtained by cutting the sheet of Example 3 was applied to an adherend having a U-shaped trough with a depth of 10 mm and a width of 15 mm.

The first comparative test substrate was manufactured in the same manner as the standard test substrate except that after the attaching to the cationic electrodeposition coated sheet, the test substrate was left standing at a temperature of 35° C. and a relative humidity of 80% RH for 3 days and then heated at a temperature of 110° C. for 15 minutes.

The second comparative test substrate was manufactured in the same manner as the standard test substrate except that after the heating at a temperature of 110° C. for 15 minutes, the test substrate was left standing at a temperature of 35° C. and a relative humidity of 80% RH for 3 days and then an automobile intermediate paint was coated thereon.

These standard test substrate, the first comparative test substrate and the second comparative test substrate were examined on the appearance with an eye, as a result, there was no difference in the appearance between the standard substrate and the first comparative test substrate or the second comparative test substrate. Also, in any Example, there was similarly no difference in the appearance between the first comparative test substrate and the second comparative test substrate.

Chipping Resistance Test

The sheet of Example 4 was cut to obtain a rectangular sample of 50 mm×100 mm. This sample was attached to a cationic electrodeposition coated sheet of 75 mm×150 mm and while keeping this state, pre-heated at a temperature of 110° C. for 10 minutes. Thereafter, an automobile intermediate baking paint was coated and then heated at a temperature of 140° C. for 18 minutes. On this automobile intermediate baking paint, an automobile topcoat paint was coated and then heated at 140° C. for 18 minutes to manufacture a test substrate.

Using the thus manufactured test substrate, a chipping resistance test was performed. Crushed stones of granite #6 were collided perpendicularly from the distance of 30 cm. At this time, the crushed stones were jetted out at an air pressure of 0.4 MPa and an air flow rate of 40 L/sec. The test temperature was in two levels of 25° C. and −20° C. In either level, there was no cracking reaching the steel sheet or damage of the test piece but only cracking of the film on the surface of the test piece was observed.

### EFFECTS OF THE INVENTION

As described in the foregoing pages, according to the present invention, a thermosetting composition capable of providing a sealing favored with excellent heat resistance and high durability while maintaining the appearance of a film formed on the sealing can be provided.

1. A sealing article comprising a thermosetting composition comprising:
an epoxy-containing material comprising a low hygroscopic epoxylated ethylene-type thermoplastic resin or a low hygroscopic epoxylated styrene-type thermoplastic resin;
a curing agent for said epoxy-containing material;
a non-metallic filler; and
a plasticizer.

2. The sealing article of claim 1, wherein the epoxy-containing material further comprises an epoxy resin selected from a bisphenol A-type epoxy resin, a bisphenol F-type epoxy resin, a novolak-type epoxy resin, or a glycidyl amine-type epoxy resin.

3. The sealing article of claim 1, wherein said epoxylated ethylene-type thermoplastic resin is an ethylene-glycidyl (meth)acrylate copolymer.

4. The sealing article of claim 1, wherein said epoxylated styrene-type thermoplastic resin is a styrene-epoxylated butadiene-styrene copolymer or a styrene-epoxylated isoprene-styrene copolymer.

5. The sealing article of claim 1, wherein the filler is calcium carbonate, silica, or a mixture thereof.

6. The sealing article of claim 1, wherein the curing agent is an amine compound, an acryl compound having a carboxyl group, a BF₃ complex, an organic acid hydrazide, a diaminomaleonitrile, a melamine, or a mixture thereof.

7. The sealing article of claim 6, wherein the curing agent is dicyandiamide.

8. The sealing article of claim 1, further comprising a curing accelerator.

9. The sealing article of claim 8, wherein the curing accelerator is an imidazole derivative or a tertiary amine.

10. The sealing article of claim 1, further comprising a polyester resin, an ethylene-vinyl acetate copolymer, or a combination thereof.

11. The sealing article of claim 1, wherein the plasticizer is a phthalic acid ester, an adipic acid ester, an epoxylated fatty acid ester, epoxylated soybean oil, epoxylated linseed oil, liquid terpene resin, phenol copolymer liquid terpene styrene copolymer, an azelaic acid ester, a sebacic acid ester, an epoxyhexaphthalic acid ester, or a mixture thereof.

12. The sealing article of claim 1, wherein the article further comprises a barrier layer.

13. The sealing article of claim 1, wherein the article comprises:
an upper layer comprising the epoxy-containing material, the curing agent, and the plasticizer;
a lower layer comprising the epoxy-containing material, the curing agent, and the filler.

14. The sealing article of claim 13, wherein the lower layer is attached to an adherend.

15. A sealing structure comprising an adherend having a discontinuous part and a thermosetting composition disposed in said discontinuous part to seal said discontinuous part, wherein the thermosetting composition comprises:
an epoxy-containing material comprising a low hygroscopic epoxylated ethylene-type thermoplastic resin or a low hygroscopic epoxylated styrene-type thermoplastic resin;
a curing agent for said epoxy-containing material;
a non-metallic filler; and
a plasticizer.

16. The sealing structure of claim 15, wherein said epoxylated ethylene-type thermoplastic resin is an ethylene-glycidyl (meth)acrylate copolymer.

17. The sealing structure of claim 15, wherein said epoxylated styrene-type thermoplastic resin is a styrene-epoxylated butadiene-styrene copolymer or a styrene-epoxylated isoprene-styrene copolymer.

18. The sealing structure of claim 15, wherein the adherend is a portion of a vehicle.

19. The sealing structure of claim 18, wherein the adherend is a roof ditch of a vehicle.

20. The sealing structure of claim 19, wherein the adherend is a side sill on the downside of a door part.
